(19) United States
(12) Patent Application Publication
(10) Pub. No.: US 2009/0043615 A1
(43) Pub. Date: Feb. 12, 2009

(54) Systems and methods for predictive data analysis

(75) Inventors: Upendra D. Belhe, Avon, CT (US); Kelly J. McLaughlin, Cobalt, CT (US); Rebecca Ann Parker, Windsor, CT (US)

Correspondence Address: ROPES & GRAY LLP, PATENT DOCKETING 39/41, ONE INTERNATIONAL PLACE, BOSTON, MA, 02110-2624, US

(73) Assignee: Hartford Fire Insurance Company, Hartford, CT (US)

(21) Appl. No.: 11/890,831

(22) Filed: Aug. 7, 2007

(51) Int. Cl. G06Q 40/00

(52) U.S. Cl. 705/4

(57) ABSTRACT

The systems and methods herein generally pertain to the computation of a likelihood that an item with a given set of characteristics will exhibit a future trait. The system generally comprises an input module for receiving the set of characteristics, a database for storing parameters relating to the set of characteristics, a computerized predictive model for estimating the likelihood, a business logic processor for executing the predictive model, and a processor for processing the set of characteristics based on its predicted likelihood.

### FIELD OF THE INVENTION

The invention relates generally to data analysis and to systems and methods for the computation of a likelihood that an item with a given set of characteristics will exhibit a future trait.

### BACKGROUND OF THE INVENTION

Insurance companies sell policies that insure against various different risks such as automobile accidents, property damage, legal liability, work related injuries, etc. Insurance companies maintain reserves, which is money that is set aside for the future payment of claims associated with those policies. It is economically desirable for an insurance company to maintain a reserve that is as close as possible to the actual liability represented by the claims. The maintenance of inadequate reserves has the effect of understating the company's liabilities on its balance sheet, which may lead to solvency problems when the company uses its surplus to pay for the claims that were not sufficiently reserved. There is a need for systems and methods of handling insurance claims efficiently and accurately estimating the cost of individual claims.

### SUMMARY OF THE INVENTION

The invention relates generally to data analysis and to systems and methods for the computation of a likelihood that an item with a given set of characteristics will exhibit a future trait. In the insurance industry, large loss claims, which are claims that have a cost greater than a value, e.g. $100,000, $250,000, or $500,000, may often have a significant impact on an insurance company's reserves and profitability. The ability to identify large loss claims early is therefore a factor in effectively managing and mitigating future exposures. The threshold cost that distinguishes large loss claims from non-large loss claims varies depending upon the type of policy that is issued and the particular financial circumstances of the issuing insurance company.

One aspect of the invention entails the use of a computer to carry out a predictive computation that estimates the likelihood that an item with a given set of characteristics will exhibit a future trait, and thus warrant special attention. For example, a computer may employ a predictive model to estimate the likelihood that an insurance claim will be a large loss claim. The determination of the likelihood that a claim will be a large loss claim preferentially is based upon parameters, including, for example and without limitation, the age of the insured, nature of the benefit, policy limitations, medical diagnoses, pharmacy costs, the need for psychiatric treatment, expect time to return to work, an employee's capacity after returning to work, whether there is a need for physical therapy or surgery, and the particular type of damage, disability or injury. This data may be stored in a data warehouse and accessed by the computer assigned to carry out the predictive computation. The predictive computation may be based on a linear regression model, a neural network, decision tree model or other statistical methods. The predictive computation may be executed at any point during the processing of a claim, however, the computation is preferentially carried out after a period of time (e.g. 30, 60 or 90 days) after receiving the notice of a particular loss. In one embodiment, the computation is carried out at least 45 days after receiving the notice of loss. Waiting a period of time allows for collection of additional data to include in the computation.

The predictive computation may be applied to new claims. It may also be applied to re-evaluate open claims on an insurance company's backlog. It may also be applied at multiple stages during the life of the processing of a claim as more data becomes available. Periodic recomputation may identify large loss claims that were not identified as such based upon the data available at earlier points in time, or when circumstances related to a claim change unexpectedly. Periodic recomputation may also identify claims as non-large loss claims that were identified as such based upon the data available at earlier points in time.

According to another aspect, the invention relates to a method of administering insurance claims based on the results of the predictive computation to more efficiently process claims. The insurance company may, for example, adjust the level of oversight with respect to the processing of claims. In addition, based on the results, resources can be assigned to have increased impact on a claimant's outcome. For example, based on each claim's predicted likelihood of being a large loss claim, the insurer can assign claims to claims handlers with a skill set and level of experience commensurate with claim, provide an appropriate level of medical review and treatment, and/or provide an appropriate level of vocational counseling. Medical review and treatment may include, without limitation, review and/or treatment from physical therapists, occupational therapists, vocational rehabilitation providers, physicians, nurses, nurse case managers, psychologists, alternative medical practitioners, chiropractors, research specialists, drug addiction treatment specialists, independent medical examiners, and social workers. The selection of the level of review and/or treatment may include a selection of a particular provider having the skills, experience, and domain knowledge applicable to the claim, an aggressiveness of treatment or review, and/or frequency of treatment or review.

The insurance company may employ the results of the predictive computation to determine the level of non-compensatory expenses the insurance company may deem appropriate for a given claim. For example, the results may be used to select an appropriate level of legal involvement to apply to the claim. For example, the computation might be used to select an attorney or law firm with the appropriate reputation, experience, skill level, and domain knowledge, to best handle the claim. The insurance company may also use the results to determine a level of non-medical investigation or analysis to apply to the claim. For example, the results may be used to determine if a private investigator or other vendor or expert should be engaged to investigate the circumstances surrounding a claim. The results may be used to assign actuaries, statisticians, or other research analysts to review the claim.

The insurance company, in various embodiments, may also make information pertaining to the claim's predicted likelihood of being a large loss claim available for the use of employees who are responsible for setting the insurance company's reserves. Any of the uses described above may be applied to all claims or only to claims that meet a specified likelihood level (e.g. a 90% likelihood of a claim being greater than $100,000, or a 75% likelihood of a claim being greater than $250,000).

### BRIEF DESCRIPTION OF THE FIGURES

The foregoing discussion will be understood more readily from the following detailed description of the invention with reference to the following figures.

FIG. 1 is a diagram illustrating a system for claim administration based upon a claim's predicted likelihood of exceeding a cost, according to one embodiment of the invention.

FIG. 2 is a flowchart of a method of generating a predictive model, according to an illustrative embodiment of the invention.

FIG. 3 is a flowchart of a method of claim administration based upon a claim's predicted likelihood of exceeding a cost, according to one embodiment of the invention.

### ILLUSTRATIVE DESCRIPTIONS

To provide an overall understanding of the invention, certain illustrative embodiments will now be described, however, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

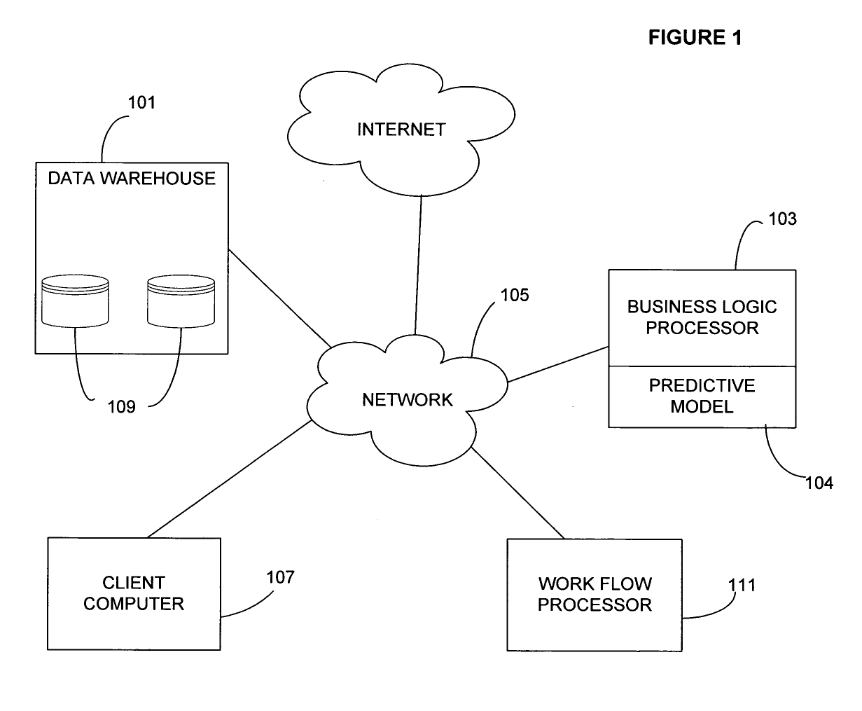

FIG. 1 is a diagram illustrating a system for claim administration based upon a claim's predicted likelihood of exceeding a cost, according to one embodiment of the invention. The system contains a data warehouse 101, a business logic processor 103, a predictive model 104, a network 105, a client terminal 107, and a workflow processor 111.

The data warehouse 101 is the main electronic depository of an insurance company's current and historical data. The data warehouse 101 includes one or more interrelated databases 109 that store information relevant to insurance data analysis. The interrelated databases 109 store both structured and unstructured data. Databases in the interrelated databases 109 may for example store data in a relational database, in various data fields keyed to various identifiers, such as, without limitation, customer, data source, geography, or business identifier (such as Standard Industry Classification code). The information stored in the data warehouse 101 is obtained through communications with customers, agents, vendors, and third party data providers and investigators. In other implementations, use of the data warehouse can be replaced with a more traditional database application without departing from the scope of the invention.

The business logic processor 103 includes one or more computer processors, a memory storing the predictive model 104, and other hardware and software for executing the predictive model 104. More specifically, the software may be computer readable instructions, stored on a computer readable media, such as a magnetic, optical, magneto-optical, holographic, integrated circuit, or other form of non-volatile memory. The instructions may be coded, for example, using C, C++, JAVA, SAS or other programming or scripting language. To be executed, the respective computer readable instructions are loaded into Random Access Memory associated with the business logic processor 103.

The predictive model 104 is used by the business logic processor 103 to estimate the likelihood that a claim will be a large loss claim, i.e., that it exceeds a cost threshold. The cost threshold may be a predetermined value. Alternatively, it may be dynamically determined based upon various parameters including, without limitation, the insurer's current reserves, the insurer's reserve ratio for the type of coverage being analyzed, the number of insurer's pending claims, and the insurer's expected revenue for the following one or more years. The cost may be a total cost, or it may include one or more of costs directly associated with a claim, such as medical costs, property damage costs, and indemnification costs, as well as insurer costs, such as legal fees, settlement fees, medical review and management, third party investigation expenses, and claim oversight costs. In alternative embodiments, the business logic processor may evaluate the likelihood that costs associated equals or falls below a threshold, without departing from the scope of the invention.

The predictive model 104 may be a linear regression model, a neural network or decision tree model, for example. The predictive model 104 may be stored in the memory of the business logic processor 103, or may be stored in the memory of another computer connected to the network 105 and accessed by the business logic processor 103 via the network 105.

The predictive model 104 preferably takes into account a large number of parameters, such as, for example, some or all of the parameters listed in Table 1, below. The evaluation period referred to in the table may be, for example, and without limitation, the first 45, 90, or 120 days after a first notice of loss is received by the insurance company.

TABLE 1
Illustrative Variables for Predictive Models

Medical invoice totals for the following (during evaluation period)
Pharmacy
Doctors office
Inpatient Hospital
Outpatient Hospital
Emergency Room
Ambulatory Surgical Center
Nursing Facility
Ambulance
Inpatient Psychiatric Facility
Community Mental Health Center
Count of visits of the following type (during evaluation period)
Emergency
Critical care
Diagnostic
Physical therapy
Surgery
Anesthesia
Radiology
Whether Primary injury is one of the following types
Nervous
Back sprain
Fracture
Dislocation
Open wounds
Musculoskeletal
Compensation coverage code (varies by state)
Network penetration (In network verses out of network medical spend)
Estimated incurred (reserved amount) at end of evaluation period
Estimated total medical spend
Accident state
Claimant age
Attorney representation (Yes or No)
Nature of benefit code
Business unit and business group
Estimated indemnity payment

The predictive model 104 is formed from neural networks, linear regressions, Bayesian networks, Hidden Markov models, or decision trees. Preferably, the predictive model 104 is trained on a collection of data known about prior insurance claims and their disposition costs, including, for example, and without limitation, the types of costs described above. In various embodiments, the particular data parameters selected for analysis in the training process are determined by using regression analysis or other statistical techniques, such as posterior probability modeling, known in the art for identifying relevant variables in multivariable systems.

In one particular embodiment, the model 104 is a linear regression model. Its parameters are selected using a stepwise selection process in concert with a profit function. The parameters can be selected from any of the structured data parameters stored in the data warehouse 101, whether the parameters were input into the system originally in a structured format or whether they were extracted from previously unstructured text, for example by a text mining software application operating within the data warehouse 106 or on another insurance company computing device. The model 104 is based on a logit function taking the form of:

$$log ( \frac{p}{1 + p} ) = {\hat{β}}_{0} + {\hat{β}}_{1} \overline{X} \qquad ( 1 )$$

where p is the probability that a claim having parameters X̅, will exceed the large loss threshold.

The model assumes binary outcomes, either:

1) a cost associated with a claim exceeds a cost threshold, i.e., the claim is a large loss claim, or

2) a cost associated with the claim falls below the cost threshold.

The set of parameters X̅ are selected for this model using a stepwise selection process that combines elements of both forward and backward selection procedures known in the art. The method is similar to that described in “Multiple regression analysis,” by M A Efroymson, in Mathematical Methods for Digital Computers, edited by A. Ralston, A. and H S Wilf (1960), the entirety of which is incorporated by reference.

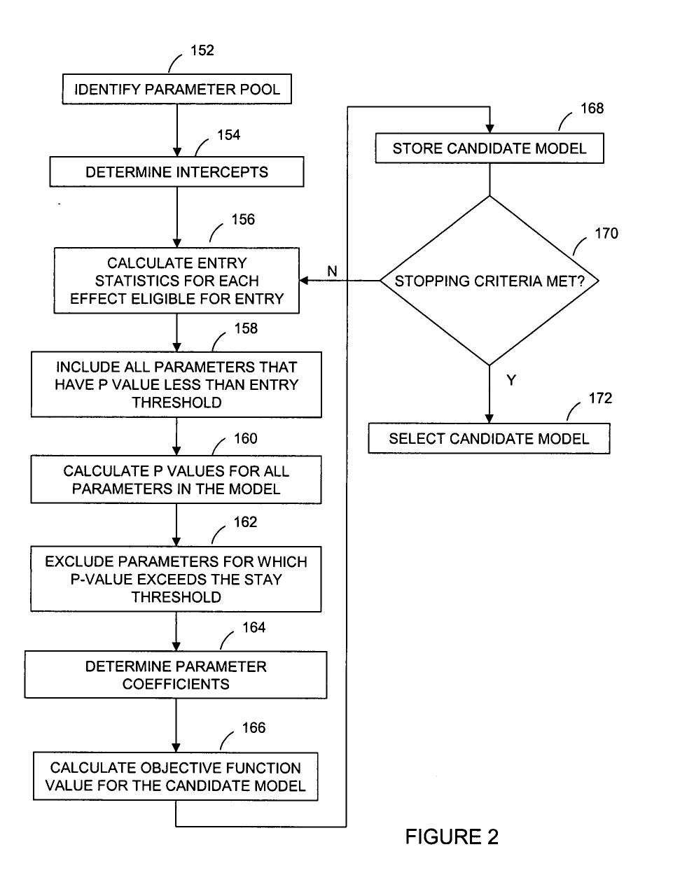

FIG. 2 is a flow chart of a method 150 for generating the predictive model 104, according to an illustrative embodiment of the invention. The method 150 begins with the identification of parameters that might be included in the linear regression model (step 152). Parameters can be identified using standard data mining techniques as well as by taking into account domain knowledge of those developing the model. In addition, function intercepts are selected for the model independent of any parameters (step 154).

From this pool of potential parameters and identified intercepts, a set of candidate models are generated and stored (steps 156-170). The process of candidate model generation begins with making an initial selection of parameters for a candidate model. To make the initial selection, p-values are calculated for all potential parameters assuming all parameters in the pool of potential parameters would be in the model (step 156). Then, all parameters having p-values below an entry threshold, for example, 0.05, are included in the initial candidate model (step 158). New p-values are determined for each of the parameters selected for inclusion in the candidate model based on just the parameters in the model (step 160). All parameters in the candidate model having a new p-value above a stay threshold, for example, 0.1, are removed from the candidate model and returned to the potential parameter pool (step 162). For the remaining parameters in the candidate model, coefficients for each of the selected variables are determined using algorithms known in the art, for example, the Newton-Raphson Ridge Optimization algorithm, the Dual Quasi-Newton Optimization algorithm, or the Dual Broyden, Fletcher, Goldfarb, and Shanno Update (DBFGS) algorithm (step 164).

The candidate model is then evaluated by an objective function (step 166), for example a profit function of the form:

E(Profit_{d})=Σp₁P_{ld} (2)

where E(Profit_{d}) corresponds to the estimated profit associated with the model, where l corresponds to a level, i.e., large loss or not large loss, and d corresponds to a decision, i.e., large loss or not large loss. Combinations of l and d result in four possible outcomes:

LL: a correct identification of a large loss claim;

NN: a correct identification of a not large loss claim;

NL: a false positive large loss claim; and

LN: a false negative large loss claim.

The profit function assumes profits, P_{LL} and P_{NN}, and losses P_{NL} and P_{LN}, associated with correct and incorrect outcomes, respectively. In this implementation, constant profits and losses are associated with each outcome. In alternative implementations, profits and losses may be determined dynamically, for example, based on how far from the large loss threshold a given claim falls. For example, a false negative outcome for a claim substantially above the threshold may yield a first cost, and false negative outcome for a claim close to the threshold may yield a second, smaller cost. In general, the profits and costs are chosen based on tolerances for false positives and false negatives.

The total profit for a candidate model P_{T} is calculated as the sum of the profits associated with the application of the candidate model to prior claims data. For a given claim c, the candidate model outputs a probability p that the claim is a large loss claim. The profit for a claim P_{C} is calculated according to the following equations:

Large Loss Claim: P_{C}=p*P_{LL}+(1−p)*P_{LN} (3)

Not Large Loss Claim: P_{C}=p*P_{NL}+(1−p)*P_{NN} (4)

The total profit P_{T} is then used to determine an average profit P_{A} for the model. The candidate model and its associated P_{A} value are then stored (step 168).

After storing the initial candidate model (step 168), the candidate model is modified to generate additional candidate models until one or more stopping criteria are met at decision block 170. For example, the process may stop if:

1) all parameters left in the potential parameter pool (i.e., all parameters not included in the current model) have already been included (at step 158) and subsequently removed (at step 162) from a candidate model due to the parameters having p-values that exceed the stay threshold,

2) a predetermined number of iterations through the process (steps 156-168) have been carried out, or

3) the parameter(s) most recently added to the model (at step 158) matches the parameter(s) removed (at step 162) from the preceding generated model.

If, at decision block 170, none of the stopping criteria have been met, the method returns to step 156, in which new p-values are calculated for the parameters left in the potential parameter pool. All parameters having p-values less than the entry threshold are added to the prior model (step 158). New p-values are calculated for the parameters in the new model (step 160) and all parameters having p-values exceeding the stay threshold are removed and returned to the candidate pool (step 162). Coefficients are calculated for the parameters of the new model (step 164) and the objective function value is calculated for the new model (step 164). The model and objective function value are stored (step 166). If, at decision block 170, one or more of the stopping criteria described above are met, the stored candidate model with highest associated average profit P_{A} is selected for use (step 172).

In validation experiments, a model built according to this methodology trained on four years of claims data was applied to 7 years of historical claim data. The model outputs a list of claims ranked by their respective likelihoods of being large loss claims. The 5% of claims most likely to be large loss claims, according to the model, included all claims that actually were reserved as large loss claims 90 days after the first notice of loss for the respective claims, during that seven year time period. In addition, the model identified claims not previously identified at the 90 day mark as being large loss claims, which eventually became large loss claims. Thus, the model has demonstrated its ability to accurately identify large loss claims early in the life of a claim.

The model generation process described above is merely one illustrative method for generating a model for use in the process described herein. Other selection processes as well as other types of models may be employed without departing from the scope of the invention. For example, in alternative implementations, the predictive model 104 can be based on expert systems or other systems known in the art for addressing problems with large numbers of variables. The model may be generated by the business logic processor 103, another computing device operated by the insurance company, or by a computing device operated by a third party having access to the insurance company's prior claims data.

The predictive model 104 may be updated from time to time as an insurance company receives additional claim data to use as a baseline for building the predictive model 104. The updating includes retraining the model based on the updated data using the previously selected parameters. Alternatively, or in addition, updating includes carrying out the parameter selection process again, based on the new data and/or adjusted profit or cost parameters in the profit function, to determine if any parameters prove to be more or less probative in the likelihood determination.

Referring back to FIG. 1, the network 105 enables the transfer of claim data between the data warehouse 101, the business logic processor 103, the client computer 107, the business workflow processor 111, and third party suppliers or vendors of data. The network includes a local area network as well as a connection to the Internet.

The client terminal 107 includes a computer that has a CPU, display, memory and input devices such as a keyboard and mouse. The client terminal 107 also includes a display and/or a printer for outputting the results of the analysis carried out by the predictive model 104. The client terminal 107 also includes an input module where a new claim may be filed, and where information pertaining to the claim may be entered, such as a notice of loss, for example. In addition to being implemented on the client terminal 107, or in the alternative, the input module may be implemented on other insurance company computing resources on the network 105. For example, the input model may be implemented on a server on the network 105 for receiving claims over the Internet from one or more websites or client applications accessed by insurance company customers, company agents, or third party preprocessors or administrators. The input module is preferably implemented as computer readable and executable instructions stored on a computer readable media for execution by a general or special purpose processor. The input module may also include associated hardware and/or software components to carry out its function. For example, for implementations of the input module in which claims are entered manually based on the notice of loss being received telephonically, the input module preferably includes a voice recording system for recording, transcribing, and extracting structural data from such notices.

The workflow processor 111 includes one or more computer processors, and memory storing data pertaining to claim handlers, supervisors, medical reviewers, medical providers, medical provider supervisor, legal services providers, private investigators, and other vendors. Stored information may include, without limitation, experience, skill level, reputation, domain knowledge, and availability. The workflow processor 111 also includes other hardware and software used to assign a claim to at least one of a claim handler, supervisor, medical reviewer, medical provider, medical provider supervisor, legal services provider, and independent investigator by the business logic processor 103. For example, in one implementation, the workflow processor 111 assigns more aggressive medical care and review to claims having higher likelihoods of becoming large loss claims, thereby applying resources to those most in need. The level of medical care and/or review management may be tiered. For example, the claims most likely to be large loss claims are assigned the most aggressive level of medical care or review. Claims having intermediate likelihood of becoming large loss claims are assigned an intermediate level of medical care or review. Claims having little likelihood of becoming large loss claims, are assigned to a lesser level of medical care or review. Medical care and review may include, without limitation, review and/or treatment from physical therapists, occupational therapists, vocational rehabilitation providers, physicians, nurses, nurse case managers, psychologists, alternative medical practitioners, chiropractors, research specialists, drug addiction treatment specialists, independent medical examiners, and social workers. The selection of the level of review and/or care may include a selection of a particular provider having the skills, experience, and domain knowledge applicable to the claim, an aggressiveness of treatment or review, and/or frequency of treatment or review. The workflow processor 111 or the business logic processor 103 may also have software configured to determine a general expense tolerance for a claim, i.e., a tolerance for expending resources on costs not associated with compensating a claimant or covered individual.

As an alternative to the illustrated FIG. 1, the physical components of the data warehouse 101, client computer 107, business logic processor 103, predictive model 104 and workflow processor 111 may be housed within the same computing device. As another alternative, the functionality of the business logic processor 103 and workflow processor 111 may be implemented on a single computing device.

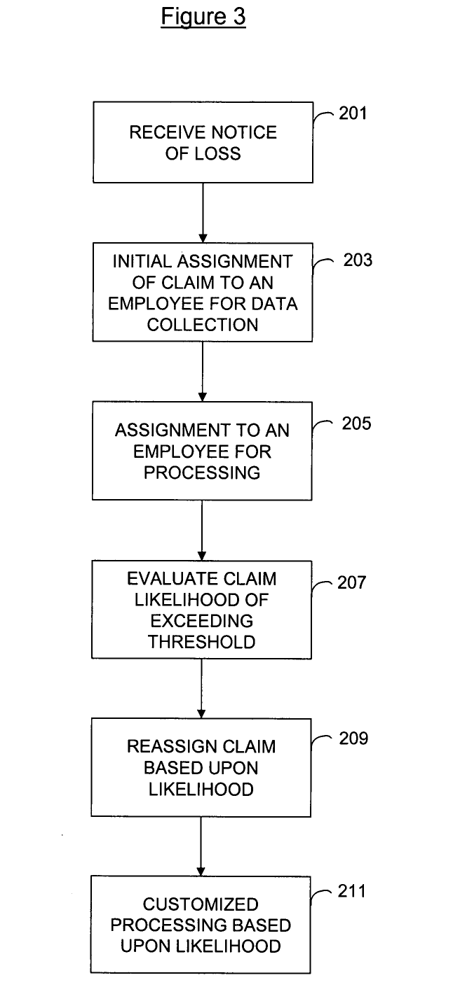

FIG. 3 is flowchart illustrating a method of claim administration based upon a claim's predicted likelihood of exceeding a cost, according to one embodiment of the invention. The method begins at step 201, when an insurance company receives a notice of loss. The notice of loss may be received from a claimant, from a pre-processor, or from a 3rd party administrator, for example. The notice of loss may be received by telephone, mail, e-mail, web page, web server, or through other data communications over the Internet. In addition, a notice of loss may be received directly or indirectly from sensors monitoring an insured property via a wireless or wired network connection.

Next, at step 203, the claim is assigned to a first employee of the company, or agent associated therewith, for the collection of basic data relating to the claim. At step 205, the claim is assigned to a second employee for processing. This step may be manual. For example, the first employee may review the collected data and make a judgment as to which second employee has the most appropriate skill set and experience level for handling the claim. Alternatively, the assignment may be automatic. For example a computer may assign the claim to the second employee based upon a series of computations relating to pre-set criteria.

After a period of time in which additional claim characteristics are collected by the employee assigned to process the claim (e.g., 30, 45, 60, or 90 days after the notice of loss) the business logic processor 103 computes a predictive estimate of the likelihood that the claim will exceed a cost threshold. The business logic processor 103 outputs a value indicating the likelihood that the claim will be a large loss claim. For example, the likelihood may take the form of probability value in the form of a probability, i.e., a numeric value between zero and one or between zero percent and one hundred percent, a tier or classification value (e.g. high likelihood, medium likelihood, or low likelihood). The likelihood value may also be a relative value comparing the likelihood of the claim becoming a large loss claim with the likelihood that other claims being processed will become large loss claims. This relative value may be an absolute ranking of the claim with respect to other pending claims, or it may be a value indicating a tranche of claims, for example, the top 5%, 10%, or 20% of claims, or top 5, top 10, or top 20 claims most likely to be large loss claims. The output likelihood value can then be used for customized processing of the claim. A data file or report may also be generated for each claim or for a group of claims, which may include data parameters associated with the characteristics of the claim or group of claims, as well as their likelihood of being a large loss claim and the ranking with respect to other pending claims. This report may then be forwarded, for example, to the client terminal 107.

Next, at step 209, the workflow processor 111 reassigns to an employee for processing based upon the likelihood value output by the business logic processor 103. Lastly, at step 211, the assigned employee processes the claim according to its likelihood of exceeding the cost. For example, the level of oversight, level of medical care and review (as described further above), the settlement strategy, non-compensatory expense tolerance, and level of factual investigation for the claim may be based on the likelihood. The likelihood may also be used in connection with setting a reserve for the claim. A ranked list of claims and data file may be used to allocate review of claims among different employees and track their development over time. In this case the data file and rankings may be updated accordingly.

In another embodiment of the invention, multiple, or all of a company's insurance claims are subject to the predictive computation. In this embodiment, the predictive computation is executed consistently at a pre-set interval, for example, once a week, to all claims that have reached a pre-set age (e.g. 30, 45, 60, or 90 days after notice of loss) during the time interval. These selected claims may then be processed according to their likelihood of exceeding the cost as described above. Alternatively, claims may be ranked according to their likelihood of exceeding the threshold cost, with those claims that are most likely (e.g. top 5%, 10% or 25% of claims, or top 5, 10 or 25 claims, etc.) to exceed the cost threshold being processed according to their likelihood of exceeding the cost. In this alternative, the number of claims that are processed may be adjusted in relation to the number of employees that are available for claim processing. Large loss likelihood for claims may be occasionally or periodically reprocessed to determine if information obtained since a previous likelihood estimation alters the likelihood that that the claim will be a large loss, meriting different processing.

What is claimed:

1. A system for analyzing data comprising:
an input module for receiving a notice of loss corresponding to an insurance claim;
a database coupled to the input module for storing at least one parameter corresponding to a characteristic of the insurance claim;
a computerized predictive model for estimating a likelihood that a cost associated with the insurance claim will have a selected relationship with a threshold value based on the stored parameter; and
one or more processors for:
executing the computerized predictive model; and
processing the insurance claim based upon the likelihood estimated by the computerized predictive model.

2. The system of claim 1, wherein the threshold value comprises a pre-determined value.

3. The system of claim 1, wherein the threshold value is determined dynamically.

4. The system of claim 1, wherein the computerized predictive model is configured for updating itself after at least one new insurance claim cost has been determined.

5. The system of claim 1, wherein the relationship includes the cost meeting or exceeding the threshold value.

6. The system of claim 1, wherein processing the insurance claim comprises making a workflow determination for the insurance claim based upon the estimated likelihood.

7. The system of claim 6, wherein the workflow determination comprises an assignment of the insurance claim to an employee from a plurality of employees to handle the claim based upon the estimated likelihood.

8. The system of claim 6, wherein the workflow determination comprises a selection of a settlement approach for the insurance claim based upon the estimated likelihood.

9. The system of claim 6, wherein the workflow determination comprises a selection of an investigation level for the insurance claim based upon the estimated likelihood.

10. The method of claim 9, wherein the selection of the investigation level comprises determining whether to engage a private investigator to investigate the claim.

11. The method of claim 9, wherein the selection of the investigation level comprises determining whether to engage an independent medical examiner to investigate the claim.

12. The system of claim 6, wherein the workflow determination comprises a selection of a level of medical review for the insurance claim based upon the estimated likelihood.

13. The system of claim 6, wherein the workflow determination comprises a selection of a level of medical care for the insurance claim based on the estimated likelihood.

14. The system of claim 6, wherein the workflow determination comprises a selection of a level of legal services to engage for the insurance claim.

15. The system of claim 1, wherein processing the insurance claim comprises adjusting a reserve based upon the estimated likelihood.

16. The system of claim 1, wherein the computerized predictive model is based upon one of a linear regression model, a neural network, and a decision tree model.

17. The system of claim 1, wherein at least one of the one or more processors is configured to wait a pre-determined number of days after the input module receives the notice of loss before executing the computerized predictive model.

18. The system of claim 1, wherein at least one of the one or more processors is configured to wait 90 days after the input module receives the notice of loss before executing the computerized predictive model.

19. The system of claim 1, wherein:
the database is configured such that the at least one parameter may be updated;
at least one of the one or more processors is configured to re-execute the computerized predictive model in response to the at least one parameter being updated to estimate a new likelihood that the cost of the insurance claim will have the selected relationship; and
at least one of the one or more processors is configured to process the insurance claim based upon the new likelihood.

20. The system of claim 1, wherein at least one of the one or more processors is configured for generating the computerized predictive model as a linear regression model by employing a stepwise parameter selection process.

21. The system of claim 1, wherein at least one of the one or more processors is configured for selecting the computerized predictive model from a plurality of candidate models based on a profit function.

22. A system for analyzing data comprising:
an input module for receiving notices of loss for a plurality of insurance claims;
a database coupled to the input module for storing at least one parameter corresponding to respective ones of the plurality of insurance claims;
a computerized predictive model for estimating likelihoods that costs of respective insurance claims in the plurality of insurance claims will have a selected relationship to a threshold value based on the stored parameter;
one or more processors for:
executing the computerized predictive model;
ranking each respective insurance claim in the plurality of insurance claims based on the respective likelihoods; and
processing at least one insurance claim in the plurality of insurance claims based upon its respective ranking.

23. The system of claim 22, wherein the selected relationship comprises the costs being greater or equal to the threshold value.

24. The system of claim 22, wherein processing the at least one insurance claim comprises making a workflow determination for the insurance claim based upon the estimated likelihood.

25. The system of claim 22, wherein the computerized predictive model is based upon one of a linear regression model, a neural network, and a decision tree model.

26. The system of claim 22, wherein at least one of the one or more processors is configured to wait a pre-determined number of days after the input module receives the notice of loss before executing the computerized predictive model.

27. The system of claim 22, wherein at least one of the one or more processors is configured for generating the computerized predictive model as a linear regression model by employing a stepwise parameter selection process.

28. The system of claim 22, wherein at least one of the one or more processors is configured for selecting the computerized predictive model from a plurality of candidate models based on a profit function.

29. A method of administering an insurance claim comprising the steps of:
receiving a notice of loss corresponding to the insurance claim;
storing at least one parameter corresponding to a characteristic of the insurance claim in a database;
using a computerized predictive model to estimate a likelihood that a cost of the insurance claim will be greater than a threshold value based on the stored parameter; and
making a workflow determination for the insurance claim based upon the likelihood that the cost of the insurance claim will be greater than the threshold value.

30. The method of claim 29, further comprising adjusting a reserve based upon the likelihood.

31. The method of claim 29, wherein the computerized predictive model is based upon one of a linear regression model, a neural network, and a decision tree model.

32. The method of claim 29, further comprising waiting a pre-determined number of days after receiving the notice of loss before using the computerized predictive model.

33. The method of claim 29, comprising generating the computerized predictive model as a linear regression model by employing a stepwise parameter selection process.

34. The method of claim 29, comprising selecting the computerized predictive model from a plurality of candidate models based on a profit function.

35. A method of administering a plurality of insurance claims comprising the steps of:
receiving notices of loss for the plurality of insurance claims;
storing a parameter corresponding to at least one characteristic of each respective insurance claim in a database;
using a computerized predictive model to estimate a likelihood that the cost of respective insurance claims will be greater than a threshold value based on the stored parameter;
ranking the insurance claims based on the likelihood that the cost of the respective insurance claims will be greater than the threshold value; and
making a workflow determination for at least one insurance claim in the plurality of insurance claims based upon its respective ranking.

36. The method of claim 35, wherein using a computerized model to estimate the likelihood that the cost of a particular insurance claim in the plurality of insurance claims will be greater than the threshold value is performed after at least a predetermined number of days after the receipt of the notice of loss corresponding to the particular insurance claim.

37. The method of claim 35, further comprising adjusting a reserve based upon the ranking.

38. The method of claim 35, wherein the computerized predictive model is based upon one of a linear regression model, a neural network, and a decision tree model.

39. The method of claim 35, comprising generating the computerized predictive model as a linear regression model by employing a stepwise parameter selection process.

40. The method of claim 35, comprising selecting the computerized predictive model from a plurality of candidate models based on a profit function.
